(19) United States
(12) Patent Application Publication
(10) Pub. No.: US 2011/0056444 A1
(43) Pub. Date: Mar. 10, 2011

(54) POLARITY SEQUENCED ELECTRO MAGNETIC HEAD GASKET ENGINE AND REPLACEMENT KIT

(76) Inventors: Chai S. IM, Hartsdale, NY (US); Seong T. IM, Yonkers, NY (US); Robert DOYLE, Paramus, NJ (US)

(21) Appl. No.: 12/877,900

(22) Filed: Sep. 8, 2010

Related U.S. Application Data
(60) Provisional application No. 61/240,487, filed on Sep. 8, 2009.

(51) Int. Cl. F02B 63/00

(52) U.S. Cl. 123/2

(57) ABSTRACT

The electromagnetic device for converting fuel based combustion engine to a hybrid or electric engine comprises an encasement with one or more electromagnets to replace a head gasket of a cyclinder of the fuel based combustion engine and a magnet connected to a top of a piston associated with the head gasket. The electromagnets in the encasement are powered by a battery and/or fuel cell. The magnet on the piston interacts with the electromagnets in the encasement to push and pull the piston within the cyclinder of the engine. The electromagnetic device further comprises a processor to control a sequence of push and pull of the piston within the cylinder of the engine by controlling the electromagnets in the encasement.

### RELATED APPLICATION

This application claims priority to U.S. Provisional Application No. 61/240,487 filed Sep. 8, 2009, which is incorporated herein by reference in its entirety.

### TECHNICAL FIELD

The claimed invention relates to an electromagnetic head gasket engine or a conversion kit that eliminates the use of gasoline or an explosive fuel with an electromagnetic replacement device to power internal combustion engine. More particularly to a polarity sequenced electromagnetic head gasket engine of the claimed invention renders the use of fuel unnecessary, in total or partially.

### BACKGROUND OF THE INVENTION

The principle behind any reciprocating internal combustion engine is that a tiny amount of high-energy fuel (e.g., gasoline) placed in a small, enclosed space releases a large amount of energy in the form of expanding gas when the high-energy fuel is ignited. For example, this resulting energy can propel a potato 500 feet by translating the energy into potato motion. The resulting energy can be also used for other interesting purposes, such as to propel a vehicle by generating cycles of these explosions. In simple terms, a vehicular engine is a device that generates a sequence or cycle of hundred explosions per minute and harnesses the resulting energy in a useful manner.

Almost all cars currently use a four-stroke combustion cycle to convert gasoline into motion. The four-stroke approach is also known as the Otto cycle, in honor of Nikolaus Otto, who invented it in 1867. The typical four strokes are 1) intake stroke; 2) compression stroke; 3) combustion stroke; and 4) exhaust stroke. A typical internal four-stroke combustion engine 1000 is illustrated in FIG. 1 showing only one piston-cylinder for simplicity. It is appreciated that the engine 1000 can have a various number of cyclinders, typically range is from 2 to 12 cyclinders for passenger vehicles.

A piston 1100 located within a cyclinder 1600 is connected to a crankshaft 1200 by a connecting rod 1300. Preferably, a rod bearing 1310 is used to connect the crakshaft 1200 to the connecting rod 1300. As the crankshaft 1200 revolves, it has the effect of “resetting the cannon.” Typical internal combustion engine 1000 goes through its cycle as follows:

INTAKE STROKE: The piston 1100 starts at the top of the cylinder 1600 (towards a head 1800), an intake valve 1400 opens an intake port 1410, and the piston 1100 moves down in the cyclinder 1600 to let the engine 1000 take in a cylinder-full of air and gasoline. Only the tiniest drop of gasoline needs to be mixed into the air (fuel/air mixture) for this to work.

COMPRESSION STROKE: The piston moves back up to the top of the cyclinder 1600 towards the head 1800 to compress the fuel/air mixture. Compression of the fuel/air mixture makes the explosion in the cyclinder 1600 more powerful.

COMBUSTION STROKE: When the piston 1100 reaches the top of its stroke (or reaches the top of the cyclinder 1600), the spark plug 1500 emits a spark to ignite the gasoline. The gasoline charge in the cylinder 1600 explodes, driving the piston 1100 down in the cyclinder 1600.

EXHAUST STROKE: Once the piston 1100 hits the bottom of its stroke (reaches the bottom of the cyclinder 1600), an exhaust valve 1700 opens an exhaust port 1710 and the exhaust leaves the cylinder 1600 to go out a tailpipe (not shown) of a vehicle (not shown).

After completing the four strokes, the engine 1000 is now ready for the next cycle and intakes another cyclinder-full of air and gasoline (i.e., the fuel/air mixture).

The motion that is generated by the internal combustion engine 1000 is rotational. In the engine 1000, the linear motion of the pistons 1100 is converted into rotational motion by the crankshaft 1200. The rotational motion is useful and desirable because the rotational motion can be readily used to turn (rotate) the car's wheels (not shown).

Currently there are millions of vehicles in the world powered by fuel-based combustion engines that continue to pollute the environment. Car companies are focused on developing new electric or hybrid vehicles that utilize electric motors to power these vehicles. That is, car companies and manufacturers are focused on replacing the currently available internal combustion engine with an electric motor. However, there appears to be no effort in converting these million vehicles into either electric or hybrid vehicles.

Therefore, the claimed invention proceeds upon the desirability of providing an electro-magnetic system to convert these million fuel-based vehicles into electric or hybrid vehicles without completely eliminating the internal combustion engines that currently power these million fuel-based vehicles.

### SUMMARY AND OBJECT OF THE INVENTION

Therefore, it is an object of the claimed invention to provide an electromagnetic device to convert fuel based combustion engine to a hybrid or electric engine.

In accordance with an exemplary embodiment of the claimed invention, the electromagnetic device for converting fuel based combustion engine to a hybrid or electric engine comprises an encasement with one or more electromagnets to replace a head gasket of a cyclinder of the fuel based combustion engine and a magnet connected to a top of a piston associated with the head gasket. The electromagnets in the encasement are powered by a battery and/or fuel cell. The magnet on the piston interacts with the electromagnets in the encasement to push and pull the piston within the cyclinder of the engine. The electromagnetic device further comprises a processor to control a sequence of push and pull of the piston within the cylinder of the engine by controlling the electromagnets in the encasement. In accordance with an aspect of the claimed invention, the magnet on the piston can be an electromagnet.

In accordance with an exemplary embodiment of the claimed invention, the electromagnetic device as aforesaid further comprises a monitor to monitor the sequence of push and pull of the piston.

In accordance with an exemplary embodiment of the claimed invention, the encasement replaces all of the head gaskets of the fuel based engine to covert the fuel based combustion engine to an electric engine.

In accordance with an exemplary embodiment of the claimed invention, the encasement replaces a subset of the head gaskets of the fuel based engine to covert the fuel based combustion engine to a hybrid engine.

In accordance with an exemplary embodiment of the claimed invention, the electromagnetic device as aforesaid further comprises a plugin port to receive power from an external power source. Preferably, the plugin port receives power from a 110 or 220 outlet.

In accordance with an exemplary embodiment of the claimed invention, the electromagnetic device as aforesaid further comprises an external generator to charge the battery, the external generator being at least one of the following: a wind generator, a rotary whell based generator, a drive shaft generator or a solar panel.

In accordance with an exemplary embodiment of the claimed invention, the electromagnetic device as aforesaid can be used with an automobile, a boat, a motorcycle, a scooter, a lawn mover, or a plane.

In accordance with an exemplary embodiment of the claimed invention, a polarity sequenced electromagnetic engine comprises an encasement of one or more electromagnets and a plurality of pistons. The encasement with one or more electromagnets on top of an engine block is connected to a battery and/or a fuel cell to power the electromagnets in the encasement. Each piston residing in a cylinder of the engine block has a magnet on a top of each piston head such that the magnets on the pistons interact with the electromagnets in the encasement to push and pull each piston within the cyclinder of the engine block. The sequence of push and pull of each piston within the cylinder of the engine block is controlled by a processor.

In accordance with an exemplary embodiment of the claimed invention, the electromagnetic engine as aforesaid further comprises a plugin port to receive power from an external power source. Preferably, the plugin port receives power from a 110V or 220V outlet.

In accordance with an exemplary embodiment of the claimed invention, the electromagnetic engine as aforesaid further comprises an external generator to charge the battery, the external generator being at least one of the following: a wind generator, a rotary wheel based generator, a drive shaft generator or a solar panel.

In accordance with an exemplary embodiment of the claimed invention, the electromagnetic engine as aforesaid can be used with an automobile, a boat, a motorcycle, a scooter, a lawn mover, a plane, a toy automobile, a toy boat, a toy motorcyle, a toy scooter, or a toy plane.

In accordance with an exemplary embodiment of the claimed invention, a polarity sequenced electromagnetic engine comprises an encasement with one or more electromagnets and a plurality of magnified pistons. The encasement with one or more electromagnets on top of an engine block is connected to a battery and/or a fuel cell to power the electromagnets in the encasement. Each magnified piston resides in a cylinder of the engine block and interacts with the electromagnets in the encasement to push and pull each magnified piston within the cyclinder of the engine block. The sequence of push and pull of each piston within the cylinder of the engine block is controlled by a processor.

In accordance with an exemplary embodiment of the claimed invention, the encasement is constructed of one of the following material: aluminum, plastic, ceramic or fiberglass.

The foregoing has outlined rather broadly the features and technical advantages of the claimed invention in order that the detailed description of the invention that follows may be better understood. Additional features and advantages of the invention will be described hereinafter which form in the subject of the claims of the invention. It should be appreciated by those skilled in the art that the specific concepts and specific embodiments disclosed may be readily utilized as a basis for modifying or designing other structures for carrying out the same purposes of the claimed invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the claimed invention.

### BRIEF DESCRIPTION OF THE DRAWINGS

The claimed invention is further explained in the description which follows with reference to the drawings, illustrating, by way of non-limiting examples, various embodiments of the invention, with like reference numerals representing similar parts throughout the several views, and wherein:

FIG. 1 is a block diagram illustrating a typical internal combustion engine piston;

FIG. 2 is a block diagram illustrating an electromagnetic head gasket engine in accordance with an exemplary embodiment of the claimed invention;

FIG. 3 is a block diagram illustrating an electromagnetic head gasket piston in accordance with an exemplary embodiment of the claimed invention; and

FIG. 4 is a block diagram illustrating an electromagnetic head gasket engine in accordance with an exemplary embodiment of the claimed invention.

### DETAILED DESCRIPTION OF THE EMBODIMENTS

An electromagnet, when energized, has a polarity of a north pole and a south pole. Magnetic flux lines go from the North Pole to the South Pole, then through the steel or ferrous core of the electromagnet, and return to the North Pole. Actually, magnetic flux is a closed loop without a starting nor finishing point. Adjusting the polarity of a direct current (DC) source to a DC electromagnet adjusts the polarity of the North Pole and the South Pole.

Electromagnet's magnetism is generated by an electrical current. So magnetism presents while the electrical current is flowing. The electromagnet generates heat as the electrical current flows, but heat does not change the magnetism of the electromagnet. It is appreciated that one can increase the magnetism of the electrical magnets by increasing the electrical current and the number of windings or turns of the magnetic coil over the steel or ferrous core of the electromagnet.

Permanent magnetism is retained after ferrous core of the electromagnet is magnetized by the electrical current. So there is a residual magnetism. A permanent magnet does not generate heat, but its magnetism is reduced by surrounding heat and eventually demagnetizes by operation over time.

In general for a given physical size, an electromagnet with a continuous duty cycle is a little weaker than a strong permanent magnet. But an electromagnet can be stronger with intermittent duty cycle. It all depends on an application and physical and environmental restraints. In another words, an electromagnet can be made very strong, if you can take the heat away from the electromagnet by lowering duty cycle or forced cooling.

TABLE 1
12 volt Holding value for a Direct Current Electromagnet

| Holding | | | Thread | Lead | | | | | |
|---|---|---|---|---|---|---|---|---|---|
| Value | Diameter | Height | Depth | Location | Lead | | | Net | |
| 0″ gap | A | B | D | E | Length | Watts | Amps | Weight | |
| 4 lb. | ½″ | 1½″ | ⅜″ | 3/16″ | 24″ | 1.4 | 0.12 | 1.8 | oz. |
| 9 lb. | ¾″ | 1¼″ | ⅜″ | 3/16″ | 24″ | 1.4 | 0.12 | 2.1 | oz. |
| 26 lb. | 1″ | ¾″ | ⅜″ | 3/16″ | 24″ | 1.4 | 0.12 | 2.3 | oz. |
| 32 lb. | 1″ | 1¼″ | ½″ | 3/16″ | 24″ | 3.6 | 0.3 | 3.3 | oz. |
| 50 lb. | 1¼″ | 1¼″ | ½″ | 3/16″ | 24″ | 4.4 | 0.37 | 5.7 | oz. |
| 150 lb. | 1¾″ | 1⅝″ | ½″ | ¼″ | 24″ | 8.5 | 0.71 | 14 | oz. |
| 180 lb. | 2″ | 1⅝″ | ½″ | ¼″ | 24″ | 5.6 | 0.47 | 1.1 | lb. |
| 200 lb. | 2″ | 2½″ | ¾″ | ½″ | 24″ | 13 | 1.1 | 2 | lb. |
| 300 lb. | 3″ | 1¼″ | ⅝″ | ½″ | 36″ | 8 | 0.7 | 3 | lb. |
| 380 lb. | 3″ | 2″ | 1″ | ⅝″ | 36″ | 19 | 1.6 | 4 | lb. |
| 400 lb. | 3″ | 3″ | 1″ | ⅝″ | 36″ | 25 | 2.1 | 5 | lb. |
| 700 lb. | 4″ | 3″ | 1″ | ⅝″ | 36″ | 36 | 3 | 9 | lb. |
| 1200 lb. | 5″ | 3″ | 1″ | ¾″ | 36″ | 43 | 3.6 | 13 | lb. |
| 800 lb. | 6″ | 1¼″ | ¾″ | ½″ | 36″ | 25 | 2.2 | 10 | lb. |
| 1700 lb. | 6″ | 3″ | 1″ | ⅞″ | 36″ | 46 | 3.8 | 20 | lb. |

Duty Cycle: Operation duty cycle is the percentage of total on-time over one complete on-off cycle within specific period. For small electromagnets, the specific time period is about 30 minutes for safety. In another words, in 30 minutes operation period, the duty cycle is the total on-time over 30 minutes in percentage. An electromagnet rated continuous duty cycle (100% duty cycle) can run continuously at normal room temperature.

The typical reach of the magnetic field is not far. Since the magnetic field or path is a loop with no beginning nor ending. The magnetic path typically consists of magnetic field inside an electromagnet core and magnetic field in air. The magnetic field in air is sometime desired field for application. Since magnetic field is a loop that can be considered from North pole of an electromagnet to air, from air to South pole of the electromagnet, from the South pole through inside of the electromagnet and to the North pole. The path of magnetic field in the air follows the rules of least reluctance path (shortest smoothed curve for easy interpretation). This is why that magnetic field can not project far away. Also, the projected magnetic field in the air reduces its strength (flux density) exponentially over the distance.

Practical ratio of field in air vs. physical size: In a continuous duty cycle, one unit magnetic field distance requires about 4 unit diameter electromagnet, e.g. 2″ diameter electromagnet usually generates magnetic field that projects about ½″ above the electromagnet. Magnetic field strength, duty cycle, cooling method, and shape of an electromagnet can dramatically alter the ratio, and all known methods for altering this ratio is contemplated within the claimed invention and are incorporated herein by reference in their entirety.

Holding Value: Listed holding value in Table 1 is the actual readings of breaking away a ½″ steel plate plunger (workpiece) with no air-gap(s) between them. Holding value will be exponentially reduced with presence of any air-gap(s). For safety in holding applications, electromagnets at more than ½ of rated value is typically not used. In lifting applications, electromagnets at more than ¼ of rated value is not recommended.

Operation temperature is also called working temperature or ambient temperature. Standard electromagnets are typically designed to work between −10° C. (14° F.) and 40° C. (104° F.) ambient temperature. If the ambient temperature is too low, it can cause cracks that leads to break inside the magnet coil or cause the insulation of lead wires to crumble (or brittle). Whereas, if the ambient temperature is too high, it can cause the inside of the magnet coil to overheat. If higher ambient temperature is desired for a particular application, then an electromagnet with a high temperature insulation material should be used.

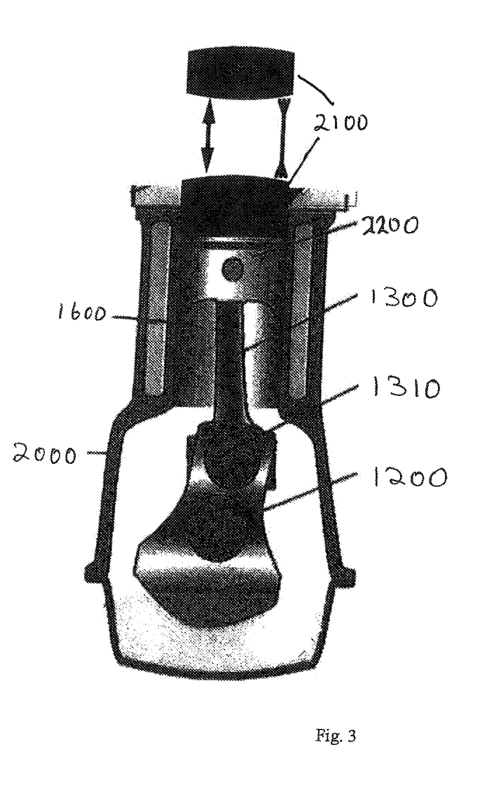

In accordance with an exemplary embodiment of the claimed invention, the fuel system of the internal combustion engine 1000 is replaced with an electromagnetic system in a proper sequence to push and pull the pistons 1100 to turn the transmission of the automobile (not shown). Preferably, the head gasket generally comprising the intake valve 1400 (including rocker arm, spring and valve cover), the intake port 1410, a head 1800 (including a camshaft), the exhaust valve 1700 (including rocker arm and spring), and the exhaust port 1710 are removed from the engine block 1000 to make room for electromagnetic replacement parts, as shown in FIG. 3.

In accordance with an exemplary embodiment of the claimed invention, a polarity sequenced electro magnetic head gasket kit is provided that eliminates the use of gasoline or an explosive fuel to power internal combustion engine 1000. The polarity sequenced electro magnetic head gasket kit of the claimed invention is used to convert a fossil-fuel based internal combustion engine 1000 to a hydrogen fuel cell or battery operated engine with alternating re-charge. The basic process of replacing the head gasket and other components of fuel based combustion engine 1000 in accordance with an exemplary embodiment of the claimed invention comprises the steps of 1) removing the head gasket and all parts/components that feed fuel to the pistons, such as carburetor, fuel injector, fuel pump, rocker arm, etc.; 2) replacing the removed parts/components with electro-magnetic plates 2100 that push and pull on the modified pistons 2200 with magnets or electromagnets 2100; and 3) adding recharging wiring to the batteries.

In accordance with an exemplary embodiment of the claimed invention, instead of replacing all of the head gaskets of the engine block (i.e., all of the piston/cyclinder assembly), one or more of the head gasket (i.e., one or more of the piston assembly) can be replaced to provide a hybrid engine. That is, for example in a four-cyclinder engine, claimed electro-magnetic system can be used to replace/convert only one cyclinder, two, three or all four cyclinders. If all four cyclinders are replaced/converted, then the claimed electro-magnetic system would provide a fully-electric engine. If only a subset of the cyclinders is replaced/converted, then the claimed electro-magnetic system would provide a hybrid engine running on both fuel and battery (and/or fuel cell).

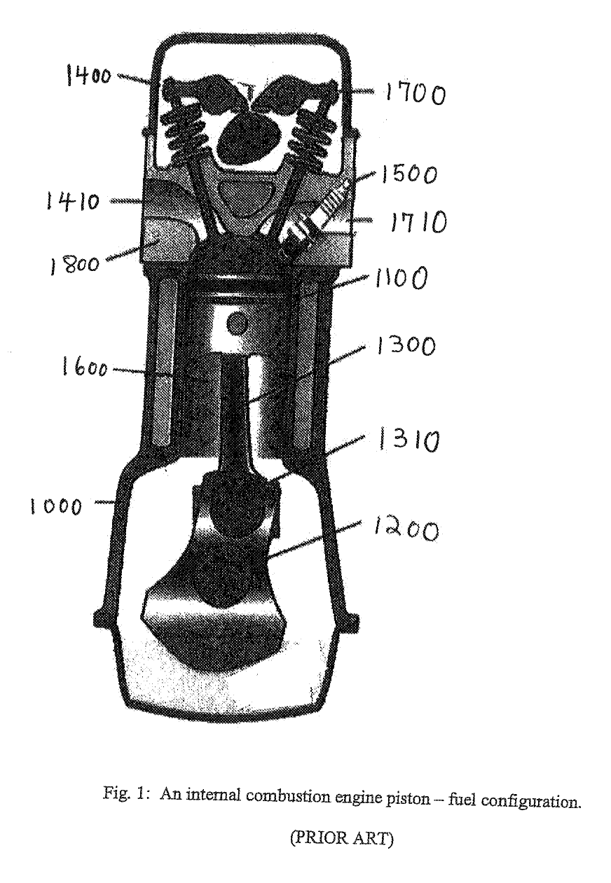

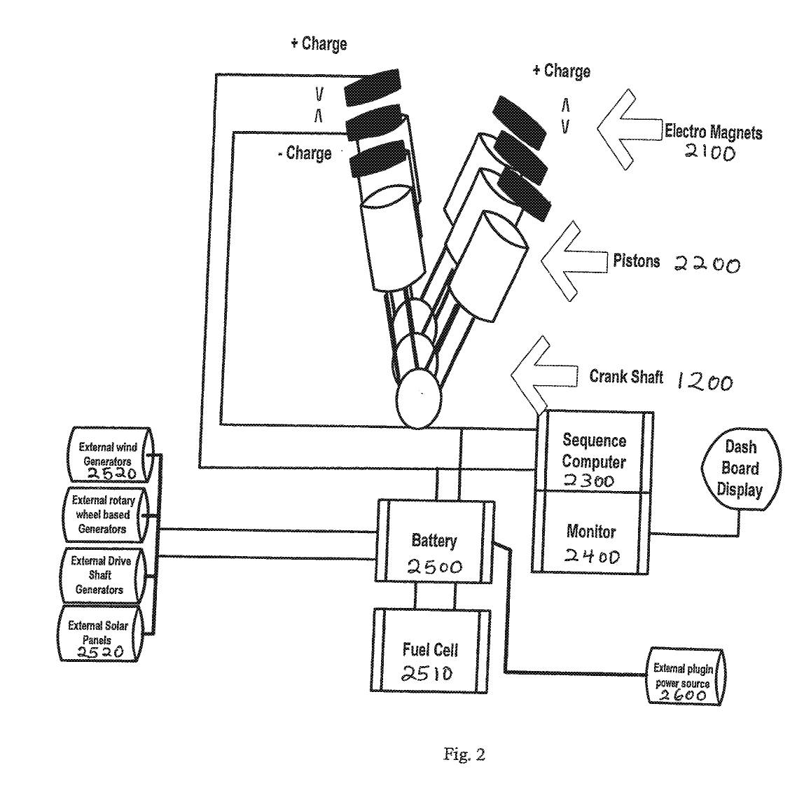

In accordance with an exemplary embodiment of the claimed invention, FIG. 2 shows the basic electro-magnetic conversion kit to convert the fossil fuel based automobile to an electric-based automobile. FIG. 2 highlights the electro-magnets 2100 that push and pull the exposed pistons 2200 (now fitted with magnets or electromagnets 2200) in a sequence that is controlled by a processor or processor-based computer 2300 to gain maximum rotations per minute (rpm) and torque to turn the drive shaft (not shown). FIG. 3 highlights the original parts to the fuel-based engine 1000 of FIG. 1 that have not been modified or replaced.

In accordance with an exemplary embodiment of the claimed invention, the existing piston 1100 of the fuel-based engine 1000 can either be replaced with a magnified 2200, a piston 1100 with electromagnet 2100 or a piston 1100 with a magnet 2100. That is, a magnet or magnetic plate can be attached or connected to the top of the piston 1100 using heat-resistant glue, a bolt or other comparable fasteners.

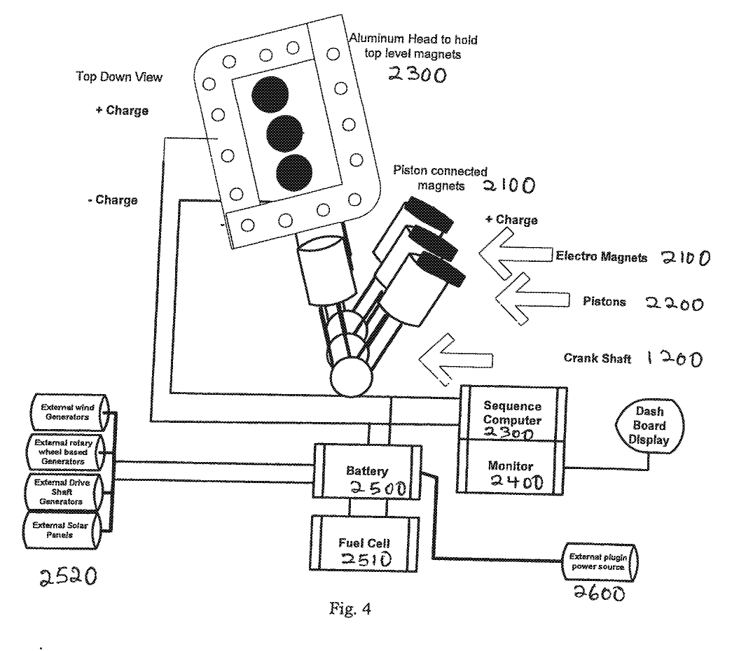

Turning now to FIG. 4, there are illustrated electromagnets 2200 in an encasement or housing 2300 on top of the engine block replacing the head gaskets and fuel parts on currently available fossil fuel based engine 1000. The encasement 2300 can be made of any durable material not capable of conducting electricity, such as aluminum, plastic, ceramic, fiberglass and the like.

In accordance with an exemplary embodiment of the claimed invention, a car dealership, an automobile repair company, car manufacturers and the like can use the claimed invention to convert the current fossil fuel based automobile to an electric based automobile by replacing the fuel based system with the claimed electro-magnetic system. The EMICECK (electromagnetic internal combustion engine conversion kit) for an automobile engine is exemplary shown in FIGS. 2-4. The electromagnets 2200 push and pull the exposed pistons 2200 (now modified with magnets or electromagnets 2200) in a sequence controlled by the processor-based computer 2300 to gain maximum rpm and torque to turn a drive shaft of the automobile. The monitor 2400 can monitor various levels, such as the charge remaining in the battery 2500, the power remaining in the fuel cell 2510, current rpm, current torque, information relating to the polarity sequence, etc. The monitor 2400 can display such information to the operator on a dash board display of the vehicle.

In accordance with an exemplary embodiment of the claimed invention, a low charge or depleted battery 2500 can recharged using external power source, such as an external plugin power 2600 (or a standard or modified 110V or 220V electric outlet) through a plugin port. It is appreciated that the battery 2500 can be rechargeable lead-acid battery or battery pack, rechargeable lithium ion based battery or battery pack, other known suitable battery or battery pack.

In accordance with an exemplary embodiment of the claimed invention, as shown in FIGS. 2 and 4, the vehicle incorporating the claimed electro-magnetic system can recharge the battery 2500 while the vehicle is stationary or in motion using one or more of the following external generators or panels 2520: external wind generators 2520, external rotary whell based generators 2520, external drive shaft generators 2520, and external solar panels 2520.

It is appreciated that the claimed polarity electromagnetic head gasket replacement kit can be used to convert any fuel-based combustion engine to an electric engine. That is, the claimed polarity electromagnetic head gasket engine can be used in an automobile, a motorcycle, a scooter, a truck, a plane, a lawn mower, a boat, a toy car, a toy plane, a toy truck, a toy motorcycle, a toy scooter, or other comparable machine or device utilizing a fuel-based engine.

In accordance with an exemplary embodiment of the claimed invention, a user can convert a fuel based engine to either a hybrid or electric engine as follows:

Removal of existing head of the fuel-based engine 1000:

Remove the engine heads 1800 in a clean, well lit, organized garage. Make sure that you have all of the tools you will need laid out and accessible. This will make the whole process much easier.

Disconnect or remove the car battery and air cleaner assembly. Disconnecting the battery is very important so you don't get electrocuted or shocked, and so the car doesn't accidentally start. Sometimes removing the car battery will allow you extra working space inside the engine compartment. Removing the air cleaner will also free up space, and you will need it to access the head 1800.

Raise your vehicle in the air, and support it with jack stands. This is important because you will need the under side to be completely accessible in order to drain fluids, unplug electrical connectors, and get to other components in order to remove your engine heads 1800. Make SURE that your vehicle is completely stable and solidly supported by the jack stands before getting underneath. Do not under any circumstance get underneath while the vehicle is resting on the jack, as those hydraulic seals can fail, causing the car to fall and cause a serious accident.

Drain all of the motor oil, and engine coolant. To drain the oil just remove the drain plug from the oil pan, and locate the oil filter and spin it off in a counter clockwise motion; if it does not come off by hand you may need an oil filter wrench. To drain the engine coolant, there is usually a valve on the bottom of the radiator near one of the corners. There is usually a drain plug on the engine block 1000 itself as well, and removing that will speed up the process.

Unplug all of the electrical connectors and vacuum lines that will interfere with removal of the engine heads 1800. This includes any grounds which bolt directly to the head, the spark plug wires, and any sensor connectors. Make sure to note their location. Sometimes it helps to either take digital pictures, or use masking tape and a marker to label the connections.

Remove the fuel supply. If you have a carbureted engine, then you need to remove the carburetor and the fuel supply lines enough so you can remove the engine head or heads 1800. If you have a fuel injected engine, then just unbolt the fuel rail with the injectors on it and swing it out of the way.

Remove any accessories, brackets, or hoses that will interfere with removal of the head or heads 1800. This might include a power steering pump or alternator. Make sure to remove any engine coolant hoses that run from the car to the head, or from the head to the heater core near the engine firewall. Now is a good time to remove the thermostat as well.

If you have a Single or Dual overhead cam engine you will need to remove the timing chain or belt. This can get pretty tricky, and from this step on it is a good idea to consult a service manual like Haynes or Alldata that is specific to your exact vehicle. The basic procedure for this is to remove the timing chain cover and compress the timing chain tensioner. When the tensioner is compressed there will be enough slack in the chain or belt to slide it off of the sprockets.

Remove the intake and exhaust manifolds. To remove the intake manifold you will need to have the air cleaner assembly off of the car as well as the fuel delivery source already removed. After this you will need to make sure that any electrical connectors are unplugged and then loosen all of the nuts and bolts, and with a slight wiggling motion, remove the manifold. If it is stuck, then gently pry up near the corners with a pry bar until it begins to give. Does the same thing for the exhaust manifold. Some of the bolts on the exhaust manifold may be hard to get out or may break, or suddenly break loose. Spraying them with penetrating oil will help. This is due to being subjected to a constant cycle of hot and cold. Watch your knuckles on this step.

Remove the valve/cam cover and cams if applicable. If your engine is an overhead cam engine you will need to remove the cams and cam cover. Remove the bolts to the cam cover slowly and about a quarter turn each until they are finger loose. Do this in an alternating criss cross pattern so you don't take all of them out in one area first, warping the cover. Then remove the cams. If your engine is an overhead valve engine, just remove the valve cover.

Remove the head bolts and the head or heads. The head bolts will be VERY hard to turn, and may require you to slip a pipe over the end of your ratchet to get enough leverage. Remove the head bolts in quarter turn increments, in a criss cross pattern until they are all finger loose, this prevents warping the head. Once they are all out, gently pry up on the corners of the head being careful not to damage the engine block surface. Once it has been broken loose, reach in with TWO hands and lift it out.

Installing the claimed ICE-MCK (Internal Combustion to ElectroMagnetic Conversion Kit):
a) Icemck configuration must match the engine model type. Installation Instructions will be packaged with ICE-MCK based on the configuration ordered.
b) Wiring Installation based on Car Model.
c) Battery configuration Based on weight/electronic features and car model.
d) Piston Magnet Installation
e) Install ICE-MCK in place of Cylinder Head.
f) Connect wiring, belts, and hoses.
g) Console Display Installation
h) Testing the ICE-MCK installation.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. An electromagnetic device to convert fuel based combustion engine to a hybrid or electric engine, comprising:
an encasement with one or more electromagnets to replace a head gasket of a cyclinder of the fuel based combustion engine connected to a battery to power the electromagnets in the encasement;
a magnet connected to a top of a piston associated with the head gasket such that magnet interacts with the electromagnets in the encasement to push and pull the piston within the cyclinder of the engine; and
a processor to control a sequence of push and pull of the piston within the cylinder of the engine by controlling the electromagnets in the encasement.

2. The electromagnetic device of claim 1, further comprising a monitor to monitor the sequence of push and pull of the piston.

3. The electromagnetic device of claim 1, wherein the encasement replaces all of the head gaskets of the fuel based engine to covert the fuel based combustion engine to an electric engine.

4. The electromagnetic device of claim 1, wherein the encasement replaces a subset of the head gaskets of the fuel based engine to covert the fuel based combustion engine to a hybrid engine.

5. The electromagnetic device of claim 1, further comprising a plugin port to receive power from an external power source.

6. The electromagnetic device of claim 1, wherein the plugin port receives power from a 110 or 220 outlet.

7. The electromagnetic device of claim 1, further comprising an external generator to charge the battery, the external generator being at least one of the following: a wind generator, a rotary whell based generator, a drive shaft generator or a solar panel.

8. The electromagnetic device of claim 1 for use with an automobile, a boat, a motorcycle, a scooter, a lawn mover, or a plane.

9. The electromagnetic device of claim 1, wherein the magnet of the piston is an electromagnet.

10. A polarity sequenced electromagnetic engine, comprising:
an encasement with one or more electromagnets on top of an engine block connected to a battery to power the electromagnets in the encasement;
a plurality of pistons, each piston residing in a cylinder of the engine block and each piston having a magnet on a top of each piston head such that the magnets on the pistons interact with the electromagnets in the encasement to push and pull each piston within the cyclinder of the engine block; and
wherein a sequence of push and pull of each piston within the cylinder of the engine block is controlled by a processor.

11. The electromagnetic engine of claim 10, further comprising a plugin port to receive power from an external power source.

12. The electromagnetic engine of claim 10, wherein the plugin port receives power from a 110 or 220 outlet.

13. The electromagnetic engine of claim 10, further comprising an external generator to charge the battery, the external generator being at least one of the following: a wind generator, a rotary wheel based generator, a drive shaft generator or a solar panel.

14. The electromagnetic engine of claim 10 for use with an automobile, a boat, a motorcycle, a scooter, a lawn mover, a plane, a toy automobile, a toy boat, a toy motorcyle, a toy scooter, or a toy plane.

15. The electromagnetic engine of claim 10, wherein the encasement is constructed of one of the following material: aluminum, plastic, ceramic or fiberglass.

16. A polarity sequenced electromagnetic engine, comprising:
an encasement with one or more electromagnets on top of an engine block connected to a battery to power the electromagnets in the encasement;
a plurality of magnified pistons, each piston residing in a cylinder of the engine block;
wherein each magnified piston interacts with the electromagnets in the encasement to push and pull each magnified piston within the cyclinder of the engine block; and
wherein a sequence of push and pull of each piston within the cylinder of the engine block is controlled by a processor.

17. The electromagnetic engine of claim 16, wherein the encasement is constructed of one of the following material: aluminum, plastic, ceramic or fiberglass.

18. The electromagnetic device of claim 1, wherein the encasement is constructed of one of the following material: aluminum, plastic, ceramic or fiberglass.

19. The electromagnetic device of claim 1, further comprising a fuel cell to provide power to the electromagnets in the encasement.

20. The electromagnetic engine of claim 10, further comprising a fuel cell to provide power to the electromagnets in the encasement.
